(19) United States
(12) Patent Application Publication
(10) Pub. No.: US 2006/0283121 A1
(43) Pub. Date: Dec. 21, 2006

(54) Panel door and method of making a panel door

(76) Inventor: Steven M. Graboyes, Alexandria, VA (US)

Correspondence Address: NATH & ASSOCIATES, 112 South West Street, Alexandria, VA, 22314, US

(21) Appl. No.: 11/444,415

(22) Filed: Jun. 1, 2006

Related U.S. Application Data
(60) Provisional application No. 60/686,043, filed on Jun. 1, 2005.

(51) Int. Cl. E06B 3/70

(52) U.S. Cl. 52/455

(57) ABSTRACT

A method of making a door and a door so made in which a board having a size of about that of the finished door is provided, an opening is cut out of the board, a peripheral inwardly extending tongue or flange is produced by cutting the edges that define the opening, a first molding having a width greater than the width of the flange is fixedly mounted on one side of the flange; a panel having a size and configuration of the hole is mounted on that part of the first molding extending beyond the flange, and a second molding having a width greater than the width of the flange is fixedly mounted on the other side of the flange so that the that part of the parts of the first and second molding overlap and sandwich the panel. In one such constructed door, the panel is smaller than the cutout opening such that the peripheral edges of the panel are spaced from the peripheral edges of the flange.

### CROSS REFERENCE TO RELATED APPLICATION

This application claims the benefit of the Provisional U.S. Patent Application Ser. No. 60/686,043, filed Jun. 1, 2005

### FIELD OF THE INVENTION

The present invention relates to a novel door and a novel method of constructing a door. In particular, the present invention relates to a high quality panel door made for example of wood, metal or a synthetic having panels made of glass, wood, metal, plastics and similar types of materials generally used in the construction of panel doors.

### BACKGROUND OF THE INVENTION

In general, most high quality panel doors usually made of wood, of the type used on public buildings, churches, synagogues, and private organizations to add a distinguishing and decorative, visually pleasing appearance to the building, have been manufactured by numerous steps, many conducted by hand by highly skilled laborers over a period of time.

Such conventional doors are comprised of individual pieces that are glued and nailed together. The panels can be either raised or depressed with respect to the plane of the door. In the case of depressed panels, the conventional, high quality door is comprised of a number of individual pieces which include top and bottom horizontally extending rails, left and right vertically extending styles, center mullions and individual panels inserted between these pieces and rigidly connected together. The panels can be raised, in which case the door can be constructed of a flat core and panels located on top of and rigidly adhered to the flat core.

The prior art is replete with examples of panel doors and panel door construction, but each has its shortcomings. The following U.S. patents, incorporated herein by reference, disclose such examples.

The U.S. Frumkin U.S. Pat. Nos. 6,684,590 and 6,584,667 disclose a method of making a panel door construction and the door so constructed. The method starts with providing two rectangular boards 22 and 45, each one-half the thickness of a finished door (see FIG. 10), and cutting corresponding rectangular openings through each board (see, e.g., Col. 2:30-37 & Col. 3:8-25 in '667 patent). A dado 38 and beading strips 41 and 43 are also cut and a panel 212 and the two door halves are glued in place to form the panel section of the door.

The Ballantyne et al. U.S. Pat. No. 5,918,434, Audia U.S. Pat. No. 5,095,675 and Shovlin published patent application No. 2003/0066257 each discloses a method of making a simulated panel door structure that includes single-body core and partial cutouts therein. In the Ballantyne et al. patent the cutouts are about ⅓ through the door face in each side opposite each other. Panels are inserted into the cutouts. (FIGS. 2-3). In the Shovlin application, a trim piece is secured within the groove (§ 0021).

The Turner U.S. Pat. No. 4,756,350 discloses a method of making a panel-style door which includes forming elongate channels in a core panel which has a rectangular outline, and length and width dimensions substantially corresponding to those of the final door (Col. 1:46-68).

However, in each of these examples, there is still a lot of hand work that is required and the resulting product has a somewhat artificial appearance. In addition, under some circumstances the inserted panels can expand an amount different from the base into which they are installed causing either a weaker door or even a door that has warped. Further, the replacement of a cracked or broken panel in the prior art panel doors is somewhat difficult, if possible at all.

Thus, there is needed a process of constructing high quality doors that have versatility, can be constructed faster, yet more accurately, have the appearance of a high quality door, and can have their panels easily removed, yet still firmly and positively retained in place.

### SUMMARY OF THE INVENTION

The present invention provides a high quality panel door that can be accurately and repeatedly made of different types of materials at a relatively rapid speed. The present invention further provides a panel door in which the panel can be easily removed and replaced, yet when installed, is strongly retained in place.

A door according to one embodiment of the invention includes a main board having a central section surrounded by peripheral edge sections, having opposed front and back major surfaces, and having an opening completely through said board central section. The opening is defined by a circumferential inward edge of an inward edge section of said board, and the opening edge section includes an inward protruding, central tongue. A front and a back molding is mounted to the board opening edge section and extends inwardly beyond the end of the tongue. The extensions of the front and back moldings define a gap therebetween. The door also includes a panel that has peripheral edges and is located in the opening with the peripheral edges thereof located in the gap defined by the front and back moldings. The panel has a shape that generally corresponds to the shape of the opening, but has planar dimensions that are smaller than planar dimensions of the opening such that the panel edge section located in the gap is spaced from the end of the tongue.

A method of making a panel door according to the present invention includes the step of cutting an opening through a solid door board having a front side and a back side, the opening being defined by board internal edges. Next a T-shaped tongue is cut in said board internal edges such that there is an internally extending central tongue portion and two side portions indented on either side thereof. Next a front molding is attached to the board internal edges and a panel is placed in said opening such that the edge of the panel is supported by the first molding. Then a back molding is attached to the board internal edges above the panel edge so that the back molding extends beyond the internal end of said flange.

Other advantages of the present invention will be discussed in the detailed description of the preferred embodiments or apparent therefrom.

### BRIEF DESCRIPTION OF THE DRAWINGS

The present invention will become better understood by reference to the following drawings, wherein:

FIG. 1 is a front elevational view of a panel door according to the present invention;

FIG. 2 is an enlarged cross-sectional view taken along line 2-2 of FIG. 1;

FIG. 3 is an enlarged cross-sectional view taken along line 3-3 of FIG. 1;

FIG. 4 is a photograph of a perspective view of a section of the panel door of FIG. 1 during the construction thereof; and

FIG. 5 is a perspective view of an “H” shaped router that is used to produce a peripheral tongue in an opening in the panel door.

### DETAILED DESCRIPTION OF THE PREFERRED EMBODIMENTS

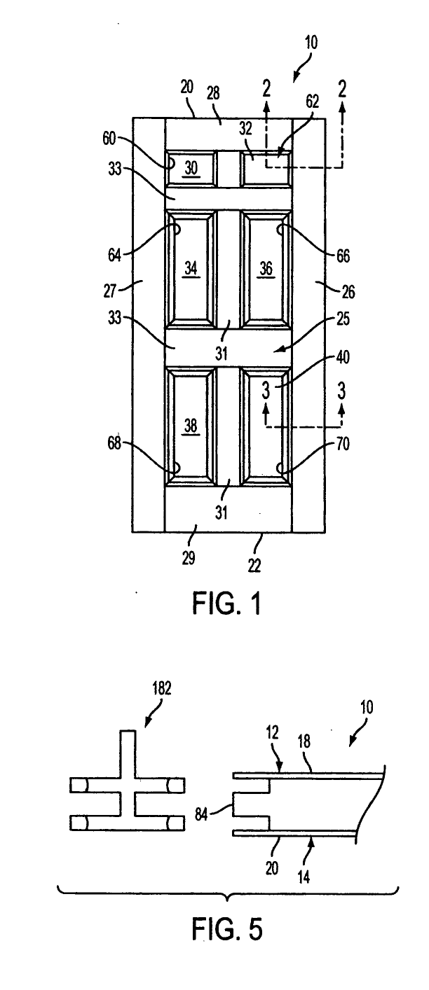

With reference now to the Figures in which like elements in the several views are designed by like numerals, and in particular with reference to FIGS. 1, 2 and 3, a panel door 10 according to the present invention is depicted. Panel door 10 has a front side 12 and a rear or back side 14. It is noted that the designation of front and back with respect to door 10 is arbitrary and the selected sides of door 10 are so designated merely for convenience in describing the present invention.

Door board 12 is comprised of a conventional planar, solid wood stable core board 16, a conventional veneer covering 18 on front side 12 and a conventional veneer covering 20 on rear side 14. Door 10 also includes solid wood end caps 22 on top and bottom horizontal edges of door 10 and side end caps 24 on the right and left vertical edges of door 10 (when installed). End caps 24 and 26 are rigidly attached to core board 16 with fasteners such as one or more of nails, adhesive and screws. Veneer coverings 18 and 20 are adhered to core board 16 with conventional means usually comprised of conventional adhesives such as polyvinyl acetate to form together with end caps 22 and 24 a composite, one piece, unitary solid board 12. Veneer coverings 18 and 20 are usually a solid quality wood sheet made of woods such as birch, pine, maple, oak or mahogany. However, veneer coverings 16 and 20 can be of other materials such as medium density fiberboard, high density composite door skin, or even a plastic laminate having a wood grain imprinted thereon. Any combination of materials can be used for veneers 18 and 20 and core board 16. End caps 22 and 24 are usually solid and made of a hard wood such as maple or oak, and often are of the same wood as that of veneer coverings 18 and 20. Core board 16 is preferably a less expensive wood product such as particle board, timber strand, wood stave lumber, flake board, medium density fiberboard, or mineralfire composite material, plywood, and chipboard. Exemplary dimensions of door 10 are 80 inches high by 36 inches wide by one and a half inch to one and three-quarters inch thick. Veneer coverings 18 and 20 are typically one-eighth inch thick.

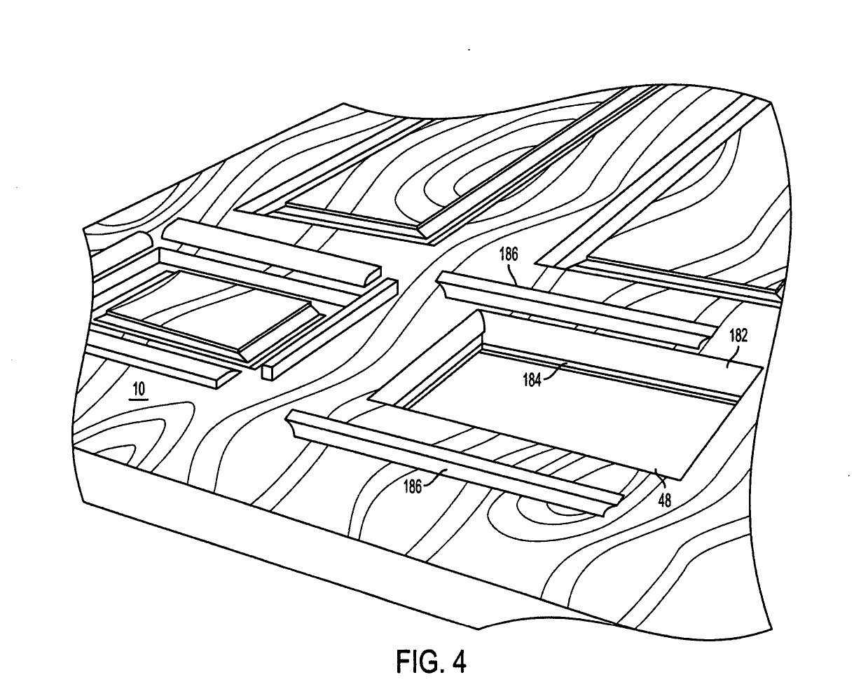

Panel door 10, as depicted in FIG. 1, has a central area 25 surrounded by two solid side sections 26 and 27 that are typically 6 inches in width and a solid top section 28 and a solid bottom section 29 that are typically 6 inches and 9 inches in width, respectively. There are also internal vertical and horizontal sections 31 and 33. Located in door area 25, and surrounded by side sections 26 and 27 and top and bottom sections 28 and 29 are six panels in three rows, two top row rectangular panels 30 and 32, two central row rectangular panels 34 and 36, and two bottom row rectangular panels 38, and 40. Panels 30, 32, 34, 36, 38, and 40 are mounted in six corresponding openings, such as opening 48 depicted in FIG. 4, as explained in greater detail herein below.

As would be obvious to those skilled in the art, the number and organization of the panels in door 10 are a matter of artistic design. The present invention is directed not to the organization of panels in door 10, but rather to the structure of the door mounting, a method of installing the panels and making door 10, and the resulting door 10.

Panels 30, 32, 34, 36, 38, and 40 can have any shape and dimension, such as square, triangular, round or oval, but are typically rectangular as depicted in FIG. 1. Further, although the corners of panels 30, 32, 34, 36, 38, and 40 have meeting orthogonal sides and square corners, the corners can be rounded or pointed. Top panels 30 and 32 have exemplary dimensions of 9.625 inches wide by 6.875 inches high and can be up to about one inch in thickness. Panels 30 and 32 are made of a conventional glass product, such as up to one inch leaded glass, or an insulated or tempered glass with a thickness of up to five-eights inch (⅝″).

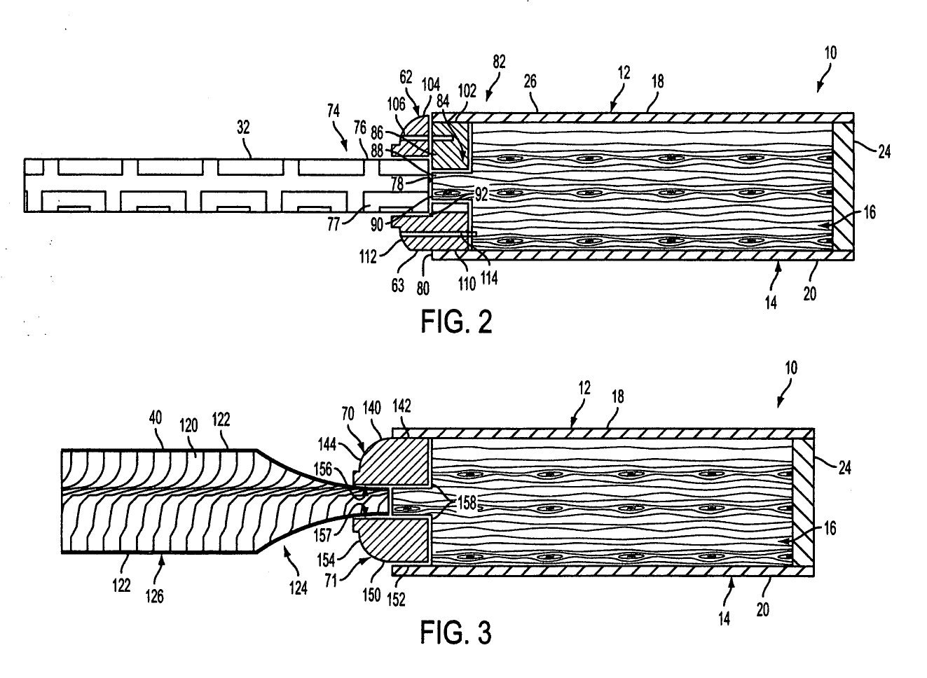

Panels 30 and 32 are enclosed by circumferential front moldings 60 and 62, respectively, together with back moldings, only back molding 53 for panel 32 being shown (see FIG. 2), described in greater detail herein below. Panels 34, 36, 38 and 40 in the embodiment of FIG. 1 are similarly enclosed by circumferential moldings, only front moldings 64, 66, 68, and 70, respectively, being shown (see FIG. 1) together with a back molding 71 for panel 40 (see FIG. 3) being shown. Panels 34, 36, 38 and 40 all have the same dimensions which are 22.75 inches high by 9½ inches wide. Panels 34, 36, 38 and 40 are of a conventional wood.

In actuality, moldings 60, 62, 63, 64, 66, 68, 70 and 71, as well as the other, not shown, back moldings for the other panels, are each comprised of four sections with adjacent sections butting up against each other at the corners of the opening containing the corresponding panel. Each molding section is typically one-half inch in width as is described in greater detail herein below. Moldings 60, 62, 63, 64, 66, 68, 70 and 71, as well as the unnumbered moldings for the other panels, are conventional, are usually a solid high quality wood, and can have any cross-sectional configuration depending upon the desired design. It is noted that the term “molding” is used herein in a generic sense and includes glazing stops and profiles.

With reference now to FIG. 2, it can be seen that panel 32 is made of glass. Panel 32 has a circumferential edge section 74 with opposed front and back sides 76 and 77 connected by a terminal edge 78 such that edge 78 is orthogonal to front and back sides 76 and 77.

Core board at opening 48 has a circumferential inward edge 80 of an inwardly extending edge section 82. Section 82 includes an inwardly protruding central tongue 84 having opposed front and back faces 86 and 88 connected by a terminal end 90. When assembled, as can be seen in FIG. 3, panel terminal edge 76 is spaced from tongue terminal end 90 to produce a gap 92. Panel 32 has a width and a height with respect to its corresponding opening such that gap 92 extends all around the circumference where panel 32 is adjacent to, but does not touch the end of tongue 84. This permits expansion of a panel and/or of door 10 without jeopardizing the structural integrity of either.

Front molding 62 is comprised of an inward first part 102 that overlaps tongue front face 86 and an outward second part 104 that extends inwardly into door opening 48. Although all moldings according to the present invention have similar inward and outward parts, in some moldings such as molding 62 the two parts are separate individual elements and in other moldings, such as back molding 63 described in detail hereinbelow, the two parts are integral and form one piece. An adhesive (not shown) fixedly attaches inward molding part 102 to tongue 84 and the base of tongue 84. A nail or tack 106 rigidly, but removably, attaches outward part 104 to inward part 102. In this way, should glass panel 32 be damaged, it can be easily replaced simply by removing tack 106 and then removing outward part 104. Outward part 104 can even be destructively removed and simply replaced by another.

Rear molding 63 is comprised of a single, unitary block having an inward section 110 that overlaps tongue back face 88 and an outward section 112 that extends inwardly into opening 48. Back molding 63 is sometimes called a glazing stop in the industry. A tack or nail 114 and an adhesive (not shown) rigidly and somewhat permanently, fixedly retain rear molding 63 in place. As can be seen in FIG. 2, outward parts 104 and 112 are spaced apart to form a gap therebetween and mutually engage and sandwich edge section 74 of panel 32.

With reference now to FIG. 3, it can be seen that panel 40 is made of wood. In one embodiment, panel 40 has a central core 120 made of bladder pressed wood and a matching veneer 122. A typical thickness of panel 40 is one and one-sixteenth inches (1 1/16″). Panel 40 has a circumferential edge section 124 integral with a main body section 126. Edge section 124 has a reduced width with respect to main body section 126 and a curvilinear cross-sectional shape. Edge section 124 has opposed front and back sides 128 and 130 connected by a terminal edge 132 such that edge 78 is orthogonal to front and back sides 128 and 130 where they meet.

As seen in FIG. 3, molding 70 is comprised of a single, one piece, integral block 140 of wood that has an inward section 142 overlapping a central tongue 84′ of core board 16 and an outward section 144 extending beyond tongue 84′ into opening 48. Molding 71 similarly is comprised of a single, one piece, integral block 150 of wood that has an inward section 152 overlapping a central tongue 84′ of core board 16 and an outward section 154 extending beyond tongue 84′ into opening 48. Block outward sections 142 and 152 have respective inward facing surfaces 156 and 157 that are spaced apart to form a circumferential gap 158 therebetween.

Nails (not shown) and an adhesive (not shown rigidly, fixedly, permanently mount molding 70 and 72 to core board 16. Because panel 40 is wood, there is little chance that it will have to be replaced. Thus, panel 40 is left floating within gap 158 and moldings 70 and 72 can be permanently attached to core board 16.

Door 10 is manufactured in a relatively fast manner. A commercial stamping machine cuts the desired number and shape of each opening 48, Reference is made to FIG. 4 wherein a door 10 is depicted in the process of being manufactured. Next a high speed, H-shaped routing tool, 180, depicted in FIG. 5, is used to fashion a T-shaped tongue 182 completely around the internal edges of opening 48 (i.e. a circumferential tongue). In some embodiments, however, it may be desirable to make tongue 182 in spaced apart sections (not shown). Next a front circumferential molding 184 (located on the bottom of door 10 as shown in FIG. 4) is mounted onto tongue 182 and core board 16. Then a panel (not shown in FIG. 4) is placed in opening 48 on the outward part of molding 184. Finally, the panel section is completed by attaching a back molding 186 onto tongue 182 and core board 16. An adhesive is selectively used to attach moldings, as explained above. Also, a nail is usually used to tack the molding in place.

The present invention has been described with respect to a number of embodiments thereof. However, other embodiments would be obvious to those skilled in the art using the teachings of this specification.

I claim:

1. A door comprising:
a board having a central section surrounded by peripheral edge sections, having opposed front and back major surfaces, and having an opening completely through said board central section, said opening defined by a circumferential inward edge of an inward edge section of said board, said opening edge section including an inward protruding, central tongue having opposed front and back faces connected by a terminal end;
a front molding mounted to said board opening edge section and extending inwardly beyond said tongue terminal end;
a back molding mounted to said board opening edge section and extending inwardly beyond said tongue terminal end, said extensions of said front and back molding defining a gap therebetween; and
a panel located in said opening having a circumferential edge section with opposed front and back sides connected by a terminal edge and having a shape of said opening, but having planar dimensions that are smaller than planar dimensions of said opening such that said panel edge section can be located in said gap yet spaced from said tongue terminal end.

2. A door as claimed in claim 1 wherein:
said board is a solid core board that has planar opposed major front and back surfaces;
said front molding has a first part overlapping said tongue front face and a second part extending inwardly beyond said tongue terminal end, said molding first part fixed to said opening inward edge section; and
said back molding has a first part overlapping said tongue rear face and a second part extending inwardly beyond said tongue terminal end, said back molding first part fixed to said opening inward edge section; and
wherein at least a portion of said panel circumferential edge section is located between said second parts of said front and rear moldings.

3. A door as claimed in claim 2 wherein at least a portion of said panel circumferential edge section is sandwiched between said second parts of said front and back moldings.

4. A door as claimed in claim 2 and further including a fastener that fixes at least one of said front and back molding first parts to said opening inward edge section wherein said fastener is an adhesive that fixes at least one of said front and back molding first parts to said opening inward edge section.

5. A door as claimed in claim 1 and further including a fastener that fixes at least one of said front and back molding first parts to said opening inward edge section.

6. A door as claimed in claim 5 wherein said fastener is a nail.

7. A door as claimed in claim 1 and further including a veneer covering at least a portion of one of said core board front and back surfaces and overlapping a part of said front or back molding, respectively.

8. A door as claimed in claim 7 wherein said veneer completely covers one of said core board front and back surfaces.

9. A door as claimed in claim 7 and also including a further veneer completely covering the other of said core board front and back surfaces, said further veneer overlapping a part of said corresponding back or front molding; and including an adhesive that rigidly attaches said overlapped veneer to said molding.

10. A door as claimed in claim 7 wherein said veneer has an outer circumferential end that is coterminous with said tongue terminal end.

11. A door as claimed in claim 1 wherein at least one of said front or back moldings is comprised of a separate first piece; and comprises an adhesive that rigidly attaches said molding to said opening edge section, and a separate second piece that is attached to said first piece.

12. A door as claimed in claim 1 wherein said opening is rectangular thereby providing four board opening inward edge sections; and wherein there are four sets of front and back moldings.

13. A door construction comprising a peripheral edge section defining a cutout in a central portion of a door, said peripheral edge having an internally extending tongue with an internally facing side, a front side and an opposing back side;
a front molding attached to said peripheral edge section and adjacent to said front tongue side edge and extending inwardly beyond said tongue internally facing side;
a back molding attached to said peripheral edge section and adjacent said second tongue side edge and extending inwardly beyond said tongue internally facing side such that said first and second molding define a slot therebetween; and
a panel having an exterior edge portion with an exterior edge, said edge portion extending into said slot with said exterior edge being adjacent to but spaced from said tongue internally facing side.

14. A door construction as claimed in claim 13 wherein said slot has a width that is greater than the thickness of said panel edge portion such that said panel is not rigidly held between said front molding and said back molding.

15. A method of making a panel door comprising:
cutting an opening in a solid door board having a front side and a back side, said opening being defined by board internal edges;
cutting a T-shaped tongue in said board internal edges such that there is an internally extending central tongue portion and two indented side portions on either side thereof;
attaching a front molding to said board internal edges;
placing a panel in said opening such that a panel edge is supported by said first molding; and
attaching a back molding to said board internal edges above said panel, said molding extending beyond the internal end of said flange.

16. A method of making a panel door as claimed in claim 15 wherein said attaching step of one of said front and back moldings includes using an adhesive to attach rigidly and non-removably said one molding to said board and said attaching step of the other of said front and back moldings includes removably, but rigidly attaching said other molding to said board.
